(19) United States
(12) Patent Application Publication
(10) Pub. No.: US 2026/0059220 A1
(43) Pub. Date: Feb. 26, 2026

(54) SOUND DEVICE

(71) Applicant: LG ELECTRONICS INC., Seoul (KR)

(72) Inventors: Giljae Lee, Seoul (KR); Hyunseung Yu, Seoul (KR); Yonghyuk Na, Seoul (KR); Minhyuck Choi, Seoul (KR); Heungsik Seo, Seoul (KR); Seunghark Paek, Seoul (KR)

(73) Assignee: LG ELECTRONICS INC., Seoul (KR)

(21) Appl. No.: 19/303,932

(22) Filed: Aug. 19, 2025

(30) Foreign Application Priority Data
Aug. 20, 2024 (KR) 10-2024-0110945

(51) Int. Cl. H04R 1/10

(52) U.S. Cl. CPC H04R 1/1075; H04R 1/1016; H04R 1/1083; H04R 2400/11; H04R 2460/01; H04R 2460/11

(57) ABSTRACT

A sound device is provided. The sound device according to the present disclosure may include: a housing; a nozzle protruding from the housing, the nozzle including an inlet which faces an inner space of the housing and an outlet which is opposite to the inlet; a transducer including a diaphragm and disposed in the inner space of the housing; and a microphone coupled to an inner surface of the housing adjacent to the inlet of the nozzle.

### CROSS-REFERENCE TO RELATED APPLICATION

This application claims the priority benefit of Korean Patent Application No. 10-2024-0110945, filed on Aug. 20, 2024, the disclosure of which is incorporated herein by reference.

### BACKGROUND OF THE INVENTION

### Field of the Invention

The present disclosure relates to a sound device.

### Description of the Related Art

Earphones are a sound device (or an electronic device) that can be inserted into a user's ears to personally listen to sounds such as music. The earphones may be wired earphones that receive input signals through a cable or wireless earphones that receive input signals through wireless communication.

The wireless earphones are on the market, which are equipped with a microphone function or provided with a button for relatively simple operations such as volume control and the like. In addition, the wireless earphones are equipped with a battery that provides power for the operation of earphones. A wireless earphone case may be provided to charge the battery.

Recently, many studies are being conducted on earphones equipped with the Active Noise Cancellation (ANC) function that reduces or blocks surrounding noise.

### SUMMARY OF THE INVENTION

It is an objective of the present disclosure to solve the above and other problems.

Another objective of the present disclosure may be to provide a sound device with improved acoustic performance.

Another objective of the present disclosure may be to provide a sound device with improved sound quality in a high (or ultra-high) frequency band.

Another objective of the present disclosure may be to provide a sound device equipped with the Active Noise Cancellation (ANC) function.

In accordance with an aspect of the present disclosure for achieving the above and other objectives, a sound device may include: a housing; a nozzle protruding from the housing, the nozzle including an inlet which faces an inner space of the housing and an outlet which is opposite to the inlet; a transducer including a diaphragm and disposed in the inner space of the housing; and a microphone coupled to an inner surface of the housing adjacent to the inlet of the nozzle.

### BRIEF DESCRIPTION OF THE DRAWINGS

The above and other objects, features and advantages of the present invention will be more apparent from the following detailed description in conjunction with the accompanying drawings, in which:

FIGS. 1 to 20 are diagrams illustrating examples of a sound device according to embodiments of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In addition, it will be noted that a detailed description of known arts will be omitted if it is determined that the detailed description of the known arts can obscure the embodiments of the present disclosure. Further, the accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

A singular representation may include a plural representation unless context clearly indicates otherwise.

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

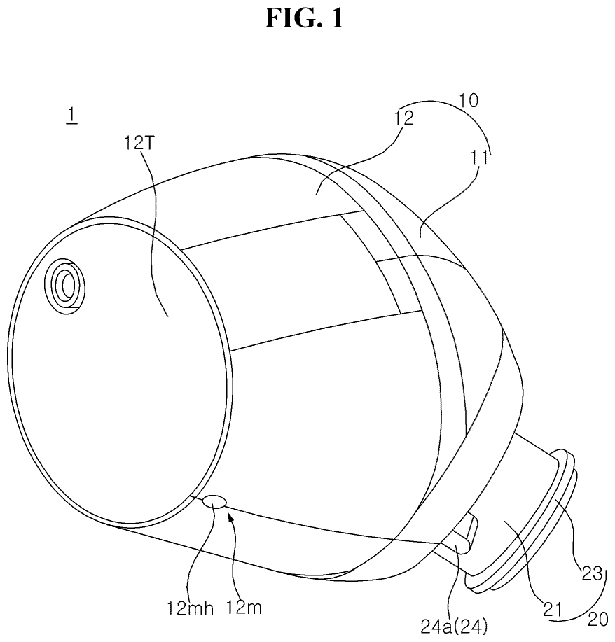

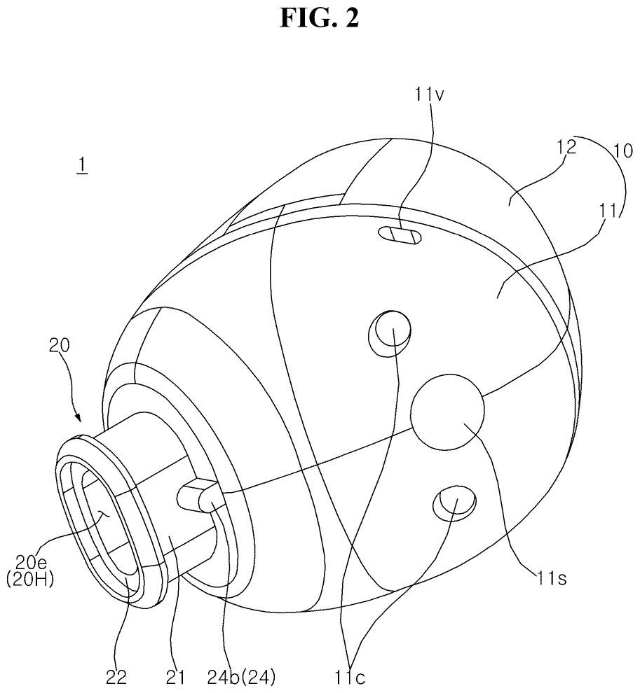

Referring to FIGS. 1 and 2, a sound device 1 may be worn on a user's cars and may play sound. For example, the sound device 1 in FIGS. 1 and 2 may be worn on the user's right car, and a sound device that is laterally symmetrical to the sound device 1 may be worn on the user's left car. The sound device 1 may be referred to as a wearable device 1, an earbud 1, an carphone 1, or True Wireless Stereo 1 (TWS). The sound device 1 may include a housing 10 and a nozzle 20.

The housing 10 may include a bottom cover 11 and a top cover 12. The bottom cover 11 may be referred to as a bottom housing 11 or a first housing 11, and the top cover 12 may be referred to as a top housing 12 or a second housing 12.

The bottom cover 11 may face a user's ear canal. The bottom cover 11 may have a generally thimble shape, and a diameter of the bottom cover 11 may decrease toward the user's car canal.

The top cover 12 may be opposite to the bottom cover 11. The top cover 12 may be generally formed in a mask shape or a truncated cone shape, and a diameter of the top cover 12 may decrease away from the user's ear canal. A top 12T of the top cover 12 may be flat. A distal end of the top cover 12 that faces the bottom cover 11 may be coupled to a distal end of the bottom cover 11 that faces the top cover 12. The bottom cover 11 and the top cover 12 may define an inner space of the housing 10.

The nozzle 20 may protrude from the bottom cover 11 and may be inserted into the user's car canal. The nozzle 20 may have a generally hollow cylindrical shape, and a diameter of the nozzle 20 may be smaller than a minimum diameter of the bottom cover 11.

A sensor 11s may be mounted on the bottom cover 11, and may detect whether the sound device 1 is worn on a user's car canal. For example, the sensor 11s may be an infrared (IR) sensor that uses light in an infrared wavelength range. The sensor 11s may be referred to as a proximity sensor 11s.

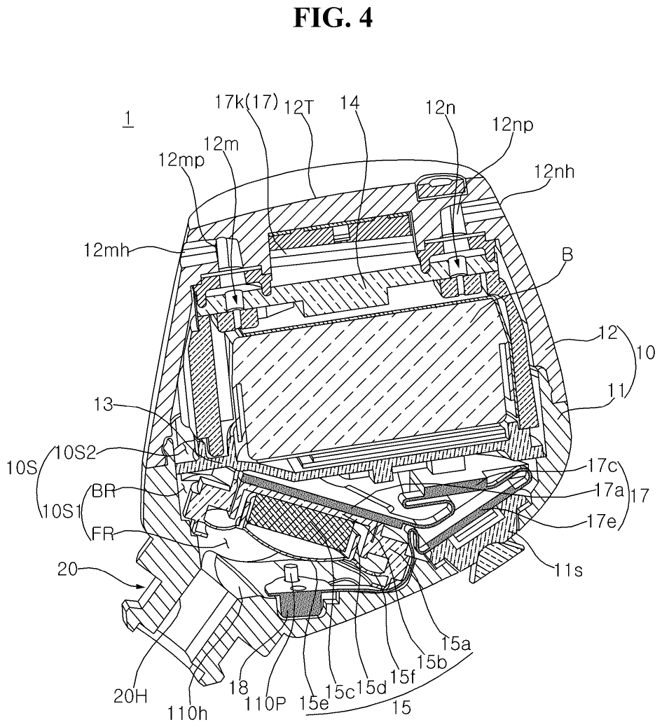

A charging terminal 11c may be mounted on the bottom cover 11, and may transmit external power to a battery B (see FIG. 4) built into the sound device 1. For example, when the sound device 1 is accommodated in a case (not shown) of the sound device, the charging terminal 11c of the sound device 1 may be electrically connected to the charging terminal of the case, and as a result, the battery built into the sound device 1 may be charged. The battery may be mounted between an inner bracket 13 and a substrate 14 which will be described later with reference to FIG. 4.

A call microphone 12m may be mounted on the top cover 12, and a user may input voice through the call microphone 12m.

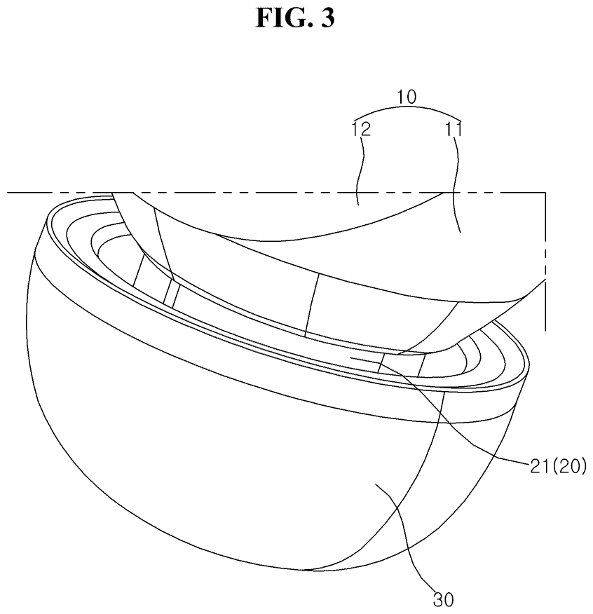

Referring to FIG. 3, the nozzle 20 may be inserted into an ear tip 30. For example, the car tip 30 may include a material, such as silicone, urethane, or rubber, etc. The car tip 30 may be pressed into the user's car canal.

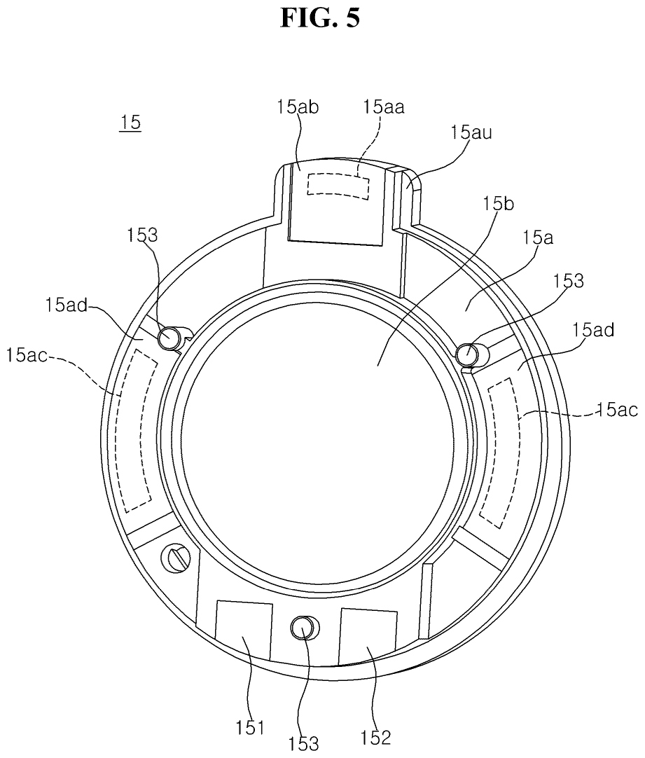

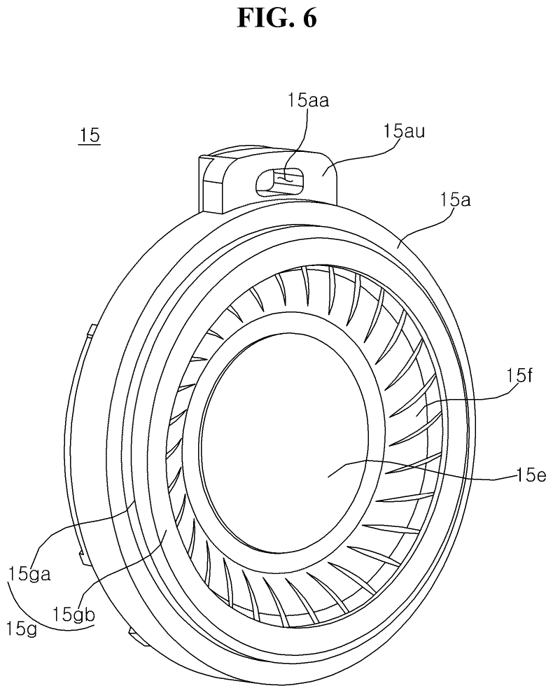

Referring to FIGS. 4 to 6, the inner bracket 13 may be adjacent to a boundary between the bottom cover 11 and the top cover 12 and positioned inside the housing 10. The inner bracket 13 may be coupled to the housing 10. The inner bracket 13 may divide an inner space 10S of the housing 10 into two spaces 10S1 and 10S2. A first space 10S1 may be located between the inner bracket 13 and the nozzle 20, and a second space 10S2 may be opposite the first space 10S1 with respect to the inner bracket 13.

A transducer 15 may be located in the first space S1 and adjacent to the inner bracket 13. The transducer 15 may be referred to as a speaker 15, a speaker unit 15, or an audio driver 15. The transducer 15 may include a frame 15a, a plate 15b, a magnet 15c, a bobbin 15d, a diaphragm 15c, and an edge 15f.

The frame 15a may be generally ring-shaped and may support the remaining components of the transducer 15. The plate 15b may be disposed in a hole (i.e., a center hole of a ring-shaped frame 15a) and coupled to the frame 15a. The plate 15b may have a round tray shape. The magnet 15c may be coupled to the plate 15b and may have a generally coin shape. The bobbin 15d may be located between a lateral surface of the magnet 15c and a side wall of the plate 15b, and may extend along the lateral surface of the magnet 15c. A voice coil may be formed or wound on the outer circumferential surface of the bobbin 15d. A first side of the diaphragm 15e may be coupled or attached to the bobbin 15d, and a second side of the diaphragm 15e may be supported by the elastic edge 15f. The diaphragm 15e may have a generally convex dome shape. Alternatively, the diaphragm 15e may also have a cone or flat membrane shape. The edge 15f may have a ring shape to connect the rim of the diaphragm 15e and the frame 15a. The edge 15f may be a portion of the diaphragm 15c.

Accordingly, when a current flows in the voice coil of the bobbin 15d located around the magnet 15c, the bobbin 15d and the diaphragm 15e may vibrate in the longitudinal direction of the bobbin 15d (i.e., axial direction of the bobbin 15d) due to Lorentz force, and the transducer 15 may output sound.

A protrusion 15au may protrude from a lateral surface of the frame 15a of the transducer 15 in a radial direction of the frame 15a.

A first hole 15aa may be formed in the protrusion 15au. The first hole 15aa may be formed through the upper and lower surfaces of the protrusion 15au. The first hole 15aa may be referred to as a guide hole 15aa. A first damper 15ab may cover the first hole 15aa. The first damper 15ab may be coupled or attached to the frame 15a. The first damper 15ab may support vibration of the transducer 15, and may include a material, such as a non-woven fabric, which allows air to pass therethrough. The first damper 15ab may be omitted.

A second hole 15ac may be formed in a portion of the frame 15a, other than the protrusion 15au. The second hole 15ac may be formed through the upper and lower surfaces of the frame 15a. The second hole 15ac may be formed in an arc shape along the frame 15a. The second hole 15ac may be referred to as a frame hole 15ac. A second damper 15ad may cover the second hole 15ac. The second damper 15ad may be coupled or attached to the frame 15a. The second damper 15ad may support vibration of the transducer 15, and may include a material, such as a non-woven fabric, which allows air to pass therethrough. A plurality of second holes 15ac may be spaced apart from each other in a circumferential direction of the frame 15a, and a plurality of second dampers 15ad may cover the plurality of second holes 15ac, respectively. The second damper 15ad may be omitted.

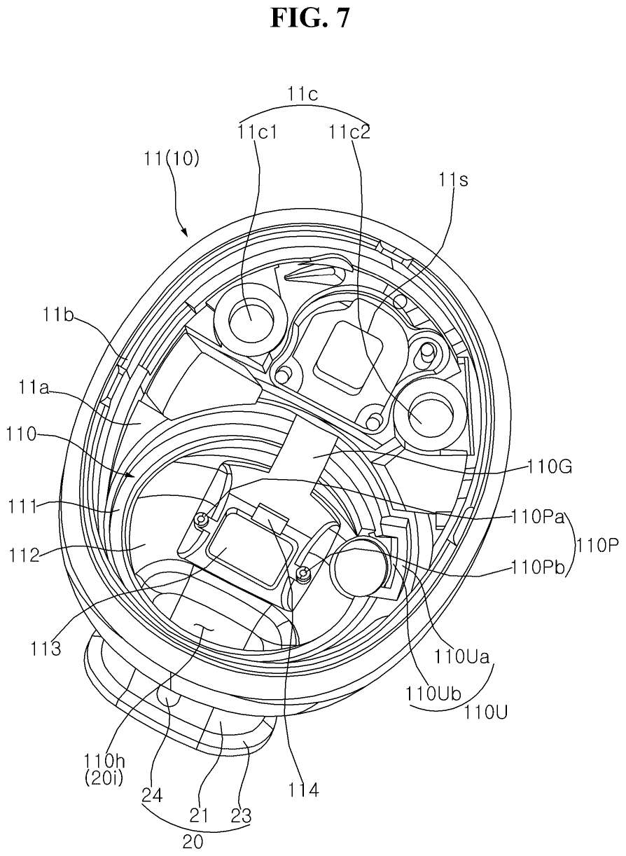

Referring to FIG. 7, the bottom cover 11 may include a bottom 11a and a side wall 11b. The bottom 11a may define a bottom portion of the bottom cover 11 and may be generally concave.

The side wall 11b may extend along the circumference of the bottom 11a and may define a lateral surface of the bottom cover 11. The sensor 11s and the charging terminal 11c may be mounted on the bottom 11a. The sensor 11s may be disposed between a first charging terminal 11cl and a second charging terminal 11c2.

A recessed portion 110 may be formed in an inner surface of the bottom 11a. The recessed portion 110 may be next to a portion of the bottom 11a on which the sensor 11 and the charging terminal 11c are mounted. The recessed portion 110 may include a first recessed portion 111, a second recessed portion 112, and a third recessed portion 113.

The first recessed portion 111 may be recessed from the inner surface of the bottom 11a. The first recessed portion 111 may form a step descending from the bottom 11a. The first recessed portion 111 may be a ring-shaped groove.

The second recessed portion 112 may be recessed from the first recessed portion 111. The second recessed portion 112 may form a step descending from the first recessed portion 111. The second recessed portion 112 may be a bowl-shaped groove.

The third recessed portion 113 may be recessed from the second recessed portion 112. The third recessed portion 113 may form a step descending from the second recessed portion 112. The third recessed portion 113 may be a rectangular groove.

The fourth recessed portion 114 may be recessed from the second recessed portion 112. The fourth recessed portion 114 may form a step descending from the second recessed portion 112 and may be connected to the third recessed portion 113. A depth of the fourth recessed portion 114 may be smaller than a depth of the third recessed portion 113. The fourth recessed portion 114 may be a rectangular groove smaller than the third recessed portion 113. The fourth recessed portion 114 may be omitted.

An opening 110h may be formed in the second recessed portion 112. The opening 110h may be adjacent to the third recessed portion 113. The opening 110h may be a circular or oval hole. The opening 110h may define an inlet 20i of the nozzle 20. The opening 110h may be referred to as a hole 110h or a housing hole 110h.

A guide pin 110P may protrude from the second recessed portion 112. The guide pin 110P may be adjacent to the third recessed portion 113. A plurality of guide pins 110P may be arranged around the third recessed portion 113. The third recessed portion 113 may be disposed between a first guide pin 110Pa and a second guide pin 110Pb.

A guide groove 110G may be formed in the first recessed portion 111 and the second recessed portion 112, and may be connected to the bottom 11a. The guide groove 111G may be an inclined path.

An insertion groove 110U may be formed in a side wall of the recessed portion 110. The insertion groove 110U may be referred to as a notch 110U. A first insertion groove 110Ua may be formed in a side wall of the first recessed portion 111. The first insertion groove 110Ua may be recessed (pressed) from the side wall of the first recessed portion 111 in a radial direction of the first recessed portion 111. A second insertion groove 110Ub may be formed in a side wall of the second recessed portion 112. The second insertion groove 110Ub may be recessed (pressed) from the side wall of the second recessed portion 112 in a radial direction of the second recessed portion 112. The second insertion groove 110Ub may be aligned with the first insertion groove 110Ua.

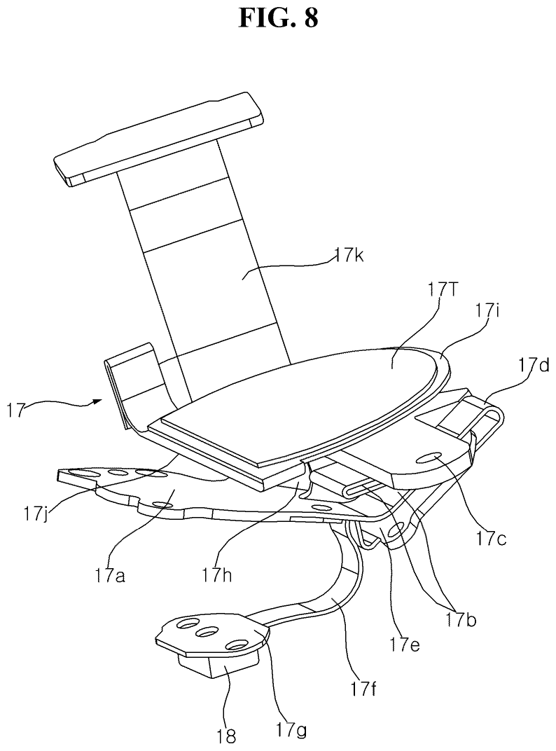

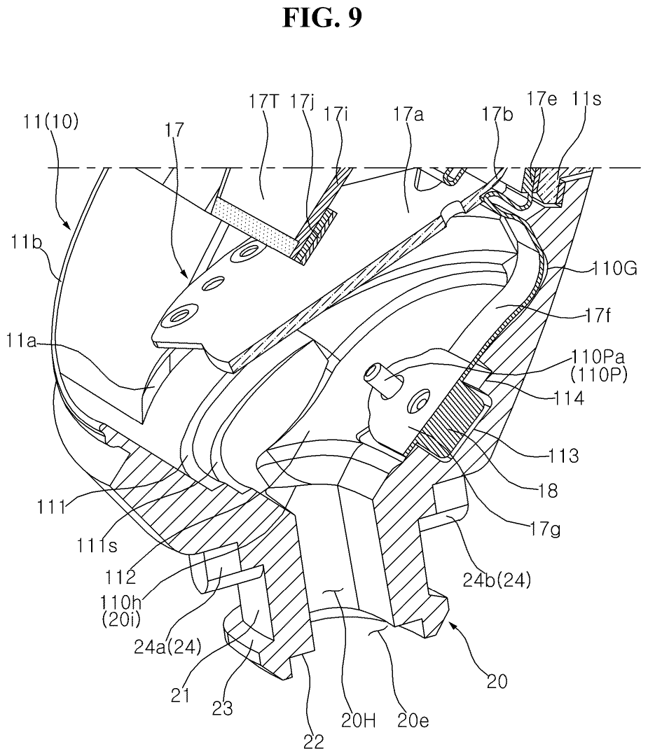

Referring to FIGS. 8 and 9, a circuit board 17 may be disposed in the inner space of the housing 10. The circuit board 17 may be a Flexible Printed Circuit Board (FPCB) 17. The circuit board 17 may include a first part 17a, a second part 17b, a third part 17c, a fourth part 17d, a fifth part 17e, a sixth part 17f, a seventh part 17g, an eighth part 17h, and a ninth part 17i.

The first part 17a may be flat. The second part 17b may be bent at least once, and a first end of the second part 17b may be electrically connected to the first part 17a. The third part 17c may be flat and electrically connected to a second end of the second part 17b. The fourth part 17d may be bent at least once, and a first end of the fourth part 17d may be electrically connected to the third part 17c. The fifth part 17e may be flat and electrically connected to a second end of the fourth part 17d. The sixth part 17f may be bent at least once, and a first end of the sixth part 17f may be electrically connected to the first part 17a. The seventh part 17g may be flat and electrically connected to a second end of the sixth part 17f. The eighth part 17h may be bent at least once, and a first end of the eighth part 17h may be electrically connected to the first part 17a. The ninth part 17i may be flat and electrically connected to a second end of the eighth part 17h. A tenth part 17j may be bent at least once and electrically connected to the ninth part 17i. An eleventh part 17k may intersect the ninth part 17i, and a first end of the eleventh part 17k may be electrically connected to the ninth part 17i.

A microphone or mic 18 may be mounted on the seventh part 17g of the circuit board 17 and electrically connected to the circuit board 17. The mic 18 may be a feedback microphone. The mic 18 may be referred to as a microphone 18.

The seventh part 17g of the circuit board 17 may cover the third recessed portion 113 and the fourth recessed portion 114 of the bottom cover 11, and the mic 18 may be inserted into the third recessed portion 113. The mic 18 may be coupled or attached to the third recessed portion 113. The seventh part 17g may be spaced apart from the bottom of the fourth recessed portion 114.

For example, the guide pin 110P may be inserted into a hole (not numbered) of the seventh part 17g and may guide coupling between the seventh part 17g and the bottom cover 11. The guide pin 110P may be formed in a rivet shape using ultrasonic waves, such that the seventh part 17g and the mic 18 may be coupled to the bottom cover 11.

In another example, the mic 18 may be bonded to the third recessed portion 113 using UV light. In this case, the guide pin 110P may be omitted.

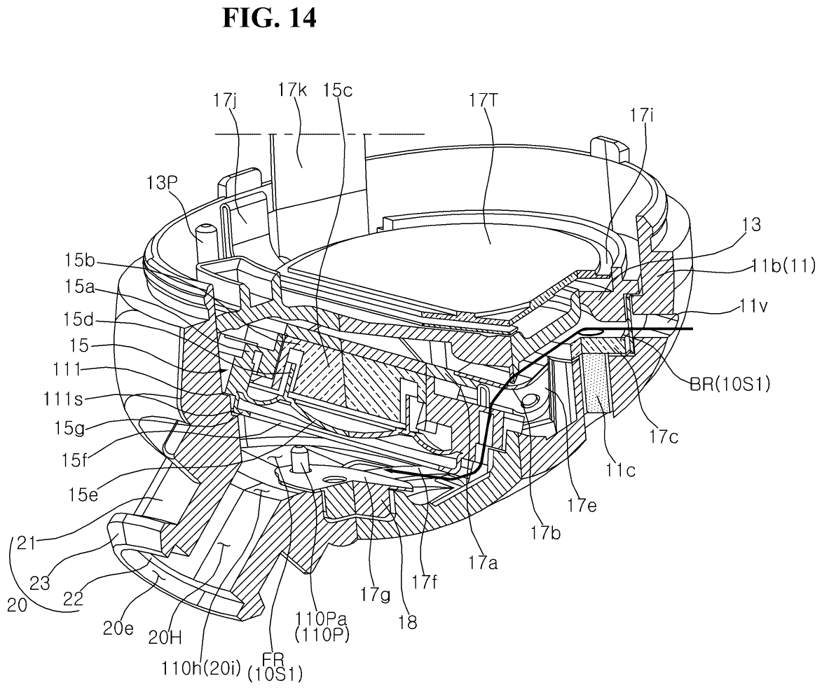

The sixth part 17f of the circuit board 17 may be disposed on the guide groove 110G of the bottom cover 11. The fifth part 17e of the circuit board 17 may be coupled to the sensor 11s mounted on the bottom 11a, and may be electrically connected to the sensor 11s. The third part 17c of the circuit board 17 may be coupled to the charging terminal 11c mounted on the bottom 11a, and may be electrically connected to the charging terminal 11c (see FIG. 14).

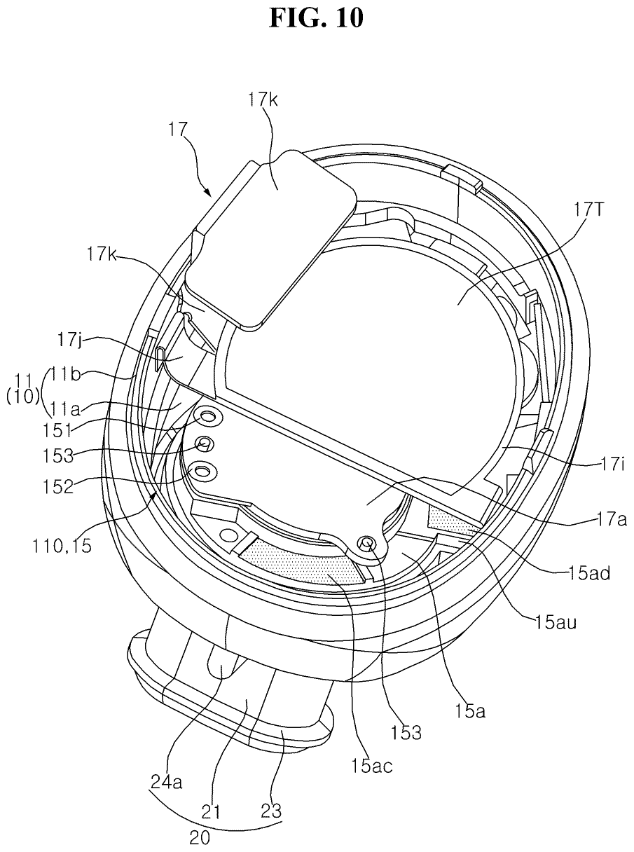

Referring to FIG. 10, the transducer 15 may be inserted into the recessed portion 110 of the bottom cover 11. The recessed portion 110 may be a groove having a shape corresponding to the transducer 15. The frame 15a of the transducer 15 may be disposed on the first recessed portion 111 (see FIG. 9). A side wall of the first recessed portion 111 may extend along the lateral surface of the frame 15a. The protrusion 15au of the frame 15a may be inserted into the first insertion groove 110Ua (see FIG. 7). The protrusion 15au and the first insertion groove 110Ua may guide coupling between the transducer 15 and the bottom cover 11.

The first part 17a of the circuit board 17 may be disposed on the transducer 15 inserted into the recessed portion 110. Terminals 151 and 152 (i.e., plus (+) or positive terminal and minus (−) or negative terminal) may be electrically connected to the first part 17a. A projection 153 may protrude from one surface (top surface) of the frame 15a that faces the first part 17a and may be inserted into a hole (not numbered) of the first part 17a. Projections 153 may be arranged along the frame 15a. The projection 153 may guide coupling between the first part 17a and the transducer 15.

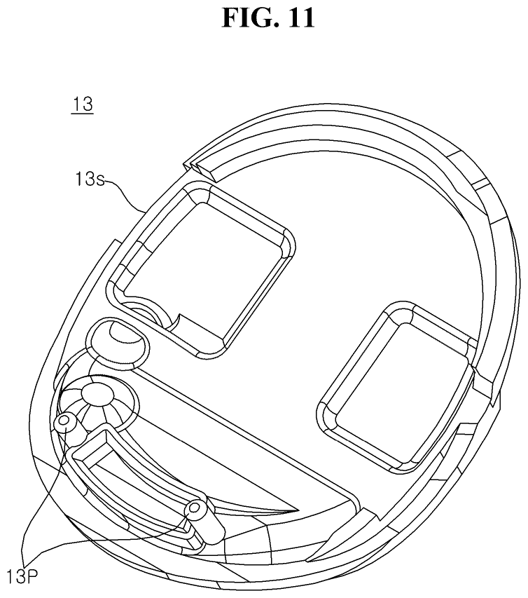

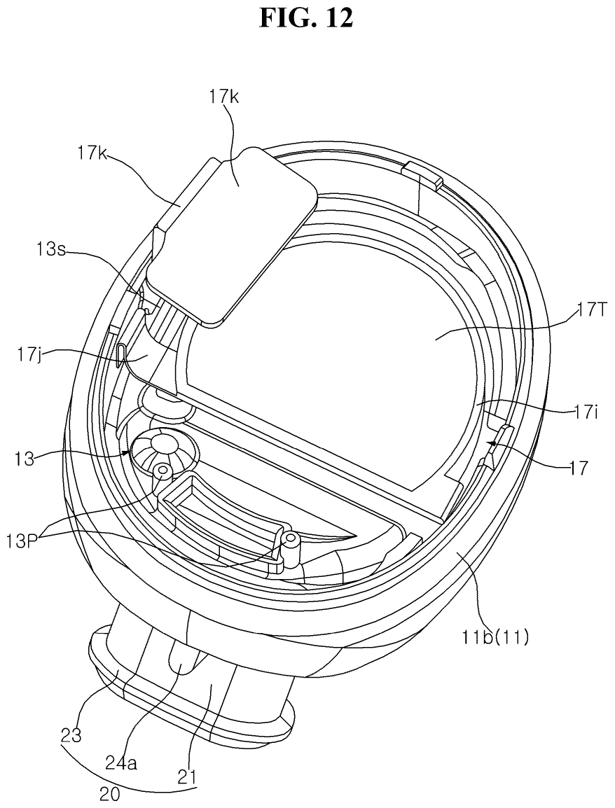

Referring to FIGS. 11 and 12, the inner bracket 13 may be disposed inside the bottom cover 11. The inner bracket 13 may be a circular or oval plate that crosses the bottom cover 11. The inner bracket 13 may cover the transducer 15 and the first part 17a of the circuit board 17 connected thereto. A slit 13s may be formed in a lateral surface of the inner bracket 13.

The ninth part 17i and the tenth part 17j of the circuit board 17 may be disposed on the inner bracket 13. The eleventh part 17k of the circuit board 17 may pass through the slit 13s and may extend above the inner bracket 13. An adhesive member 17T, such as double-sided tape, may be coupled to the ninth part 17i.

A fixing pin 13P may protrude from one surface of the inner bracket 13 that faces the ninth part 17i. The fixing pin 13P may be spaced apart from the ninth part 17i. A plurality of fixing pins 13P may be spaced apart from each other.

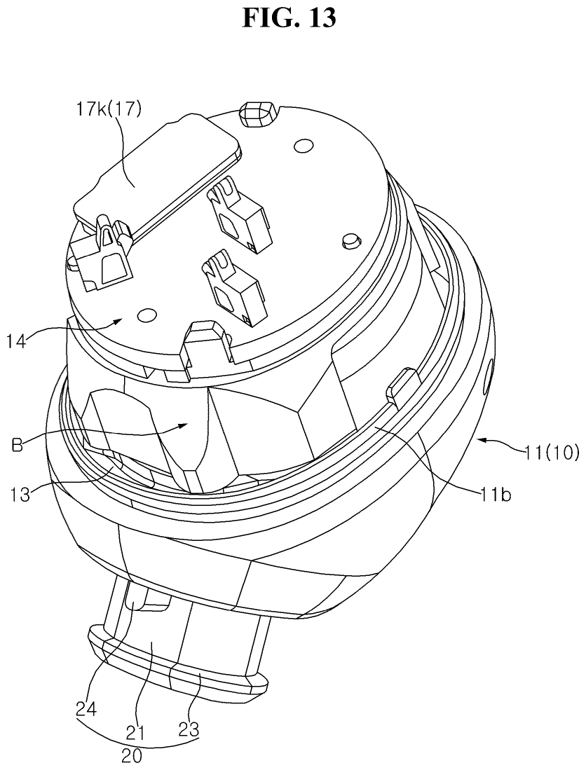

Referring to FIG. 13, the battery B may be disposed on the inner bracket 13. The battery B may be coupled to the fixing pin 13P (see FIG. 12) of the inner bracket 13. The battery B may be coupled to the adhesive member 17T (see FIG. 12) on the inner bracket 13. The battery B may be a rechargeable battery. The battery B may be in the form of a cylinder or elliptical cylinder.

The substrate 14 may be disposed on the battery B. The substrate 14 may be coupled to the battery B. The substrate 14 may be a Printed Circuit Board (PCB) in the shape of a circular plate.

Referring back to FIG. 4, the inner bracket 13 may divide an inner space 10S of the housing 10 into a first space 10S1 and a second space 10S2. The transducer 15 and the mic 18 may be located in the first space 10S1, and the battery B and the substrate 14 may be located in the second space 10S2. Sound waves generated by the transducer 15 may be provided to the nozzle 20 through the opening 110h of the bottom cover 11.

A microphone hole 12mh may be formed in the top cover 12. The microphone hole 12mh may be an inlet of a path 12mp formed through the top cover 12. An outlet of the path 12mp, which is opposite to the inlet, may face the call microphone 12m mounted on the substrate 14. A user's voice may be provided to the microphone 12m through the path 12mp. The call microphone 12m may be referred to as a talk microphone 12m.

A top hole 12nh may be formed in the top cover 12. The top hole 12nh may be an inlet of a path 12np formed through the top cover 12. An outlet of the path 12np, which is opposite to the inlet, may face a noise recognition microphone 12n mounted on the substrate 14. Air (or sound waves) may be provided to the noise recognition microphone 12n through the path 12np. The noise recognition microphone 12n may recognize noise. The top hole 12nh may be referred to as a noise inflow hole 12nh. The noise recognition microphone 12n may be electrically connected to the transducer 15 (see FIG. 10) through the circuit board 17 (see the eleventh part 17k of FIG. 13 and the first part 17a of FIG. 10) connected to the substrate 14. The transducer 15 may play sound that has an anti-phase with respect to the noise acquired from the noise recognition microphone 12n, and may cancel out the noise.

The mic 18 may detect whether the transducer 15 plays sound having an anti-phase with respect to the noise flowing into the top hole 12nh, and may provide feedback to the transducer 15. The mic 18 may be referred to as a feedback mic 18. The noise recognition microphone 12n may be referred to as a feedforward microphone 12n.

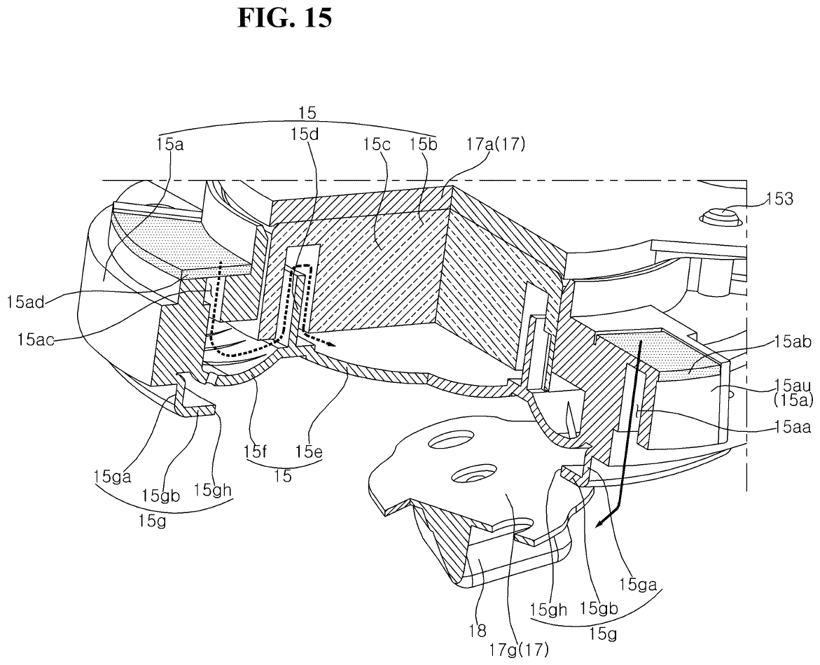

Referring to FIGS. 14 and 15, a bottom hole 11v may be formed in the bottom cover 11. The bottom hole 11v may be formed through an outer surface and an inner surface of the side wall 11b of the bottom cover 11. The bottom hole 11v may face a space BR between the inner bracket 13 and the transducer 15. The first space 10S1, in which the transducer 15 is located, may include a back room BR between the bottom hole 11v and the transducer 15 and a front room FR between the transducer 15 and the opening 110h. The mic 18 may be located in the front room FR. The mic 18 may face the front room FR.

Air (or sound waves) may pass through the bottom hole 11v, the back room BR, and the transducer 15 to flow into the mic 18 of the front room FR.

The first hole 15aa may be formed in the protrusion 15au of the transducer 15 and may define an air flow path that connects the front room FR and the back room BR. In this case, pores of the first damper 15ab may communicate with the first hole 15aa. Alternatively, the first damper 15ab may be omitted. Air (or sound waves) having passed through the bottom hole 11v and the back room BR may pass through the first hole 15aa to flow into the mic 18 of the front room FR (see the arrow with solid line in FIGS. 14 and 15).

The second hole 15ac may be formed in the frame 15a of the transducer 15 and may define an air flow path that connects the back room BR and the inside of the transducer 15. In this case, pores of the second damper 15ad may communicate with the second hole 15ac. Alternatively, the second damper 15ad may be omitted. Air (or sound waves) having passed through the bottom hole 11v and the back room BR may be introduced between the frame 15a and the edge 15f through the second hole 15ac, and may be introduced between the magnet 15c and the diaphragm 15e through a gap around the bobbin 15d (see the arrow with dotted line in FIG. 15). The air introduced between the magnet 15c and the diaphragm 15e may allow the diaphragm 15e to vibrate, and noise corresponding to the vibration may be input to the mic 18 of the front room FR.

The mic 18 may recognize noise. The mic 18 may be electrically connected to the transducer 15 through the circuit board 17 (see the seventh part 17g and the first part 17a). The transducer 15 may play sound that has an anti-phase with respect to the noise, and may cancel out the noise.

In addition, the pressure in the internal auditory canal of a user wearing the sound device 1 on the car may be relieved through the nozzle 20, the opening 110h, the front room FR, the first hole 15aa of the transducer 15, the back room BR, and the bottom hole 11v. The bottom hole 11v may be referred to as a vent hole 11v or a duct hole 11v.

A rib 15g may be formed on the frame 15a of the transducer 15. The rib 15g may be an annular rib 15g extending along the edge 15f of the transducer 15. A hole 15gh may be formed in a central portion of the rib 15g, and the center of the hole 15gh may be located corresponding to the center of the diaphragm 15e. That is, in the axial direction of the transducer 15, the center of the hole 15gh may be aligned with the center of the diaphragm 15e or may be slightly offset from the center of the diaphragm 15e. The rib 15g may include a first part 15ga and a second part 15gb.

The first part 15ga may be adjacent to a distal end of the edge 15f and may protrude from the frame 15a and extend along the edge 15f. The second part 15gb may be bent from the first part 15ga and may extend along the first part 15ga. The second part 15gb may define the boundary of the hole 15gh. The second part 15gb may cover at least a portion of the edge 15f and may be spaced apart from the edge 15f. The second part 15gb may be disposed on a support portion 111s of the bottom cover 11. Here, the support portion 111s (see FIG. 9) may protrude from a side wall of the second recessed portion 112, and may support at least a portion of the second part 15gb.

Accordingly, the rib 15g may protect the edge 15f. The edge 15f may be a part of the diaphragm 15c.

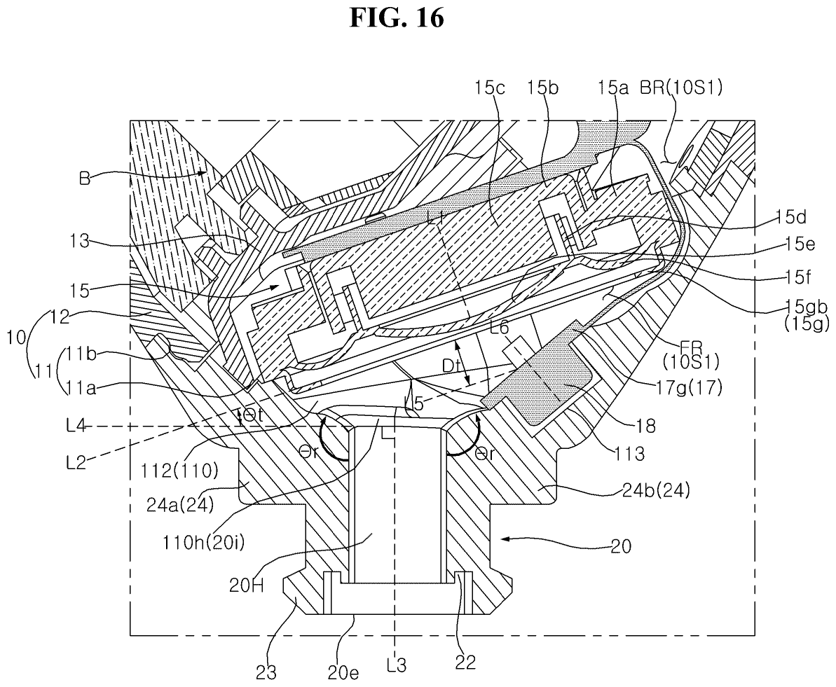

Referring to FIG. 16, the nozzle 20 may have a generally hollow cylindrical shape. A body 21 of the nozzle 20 may protrude from the bottom cover 11 and may define a hollow space 20H of the nozzle 20. The body 21 may be referred to as a nozzle wall 21, and the hollow space 20H may be referred to as a channel 20H or a path 20H. An inlet 20i of the nozzle 20, i.e., an inlet of the hollow space 20H, may face the inside of the bottom cover 11. The opening 110h of the bottom cover 11 may define the inlet 20i of the nozzle 20. An outlet 20e of the nozzle 20, i.e., the outlet of the hollow space 20H, may be opposite to the inlet and may face the outside thereof. Accordingly, sound waves generated by the transducer 15 and/or the mic 18 may be provided to the outside of the sound device 1 through the hollow space 20H of the nozzle 20.

A groove 22 may be formed at a distal end of the body 21. A plate (not shown) having a plurality of holes may be mounted in the groove 22. The rib 23 may be adjacent to the distal end of the body 21 and formed on an outer surface of the body 21. The rib 23 may extend along a lateral surface of the body 21. A projection 24 may be opposite to the rib 23 and formed on the outer surface of the body 21. A plurality of projections 24a and 24b may be spaced apart from each other. The car tip 30 (see FIG. 3) may be removably coupled to the nozzle 20.

A diameter of the diaphragm 15e of the transducer 15 may be greater than a diameter of the hollow space 20H of the nozzle 20. A center axis L1 of the transducer 15 may pass through the center of the diaphragm 15e. The center axis L1 of the transducer 15 may also pass through the center of the magnet 15c and the center of the plate 15b. The transducer 15 may face the nozzle 20 or may be inclined relative to the nozzle 20.

For example, the center axis L1 of the transducer 15 may not be aligned with or parallel to a center axis L3 of the nozzle 20, but may intersect the center axis L3. The center axis L3 of the nozzle 20 may be an axis passing through the center of the hollow space 20H. The center axis L1 of the transducer 15 may not pass through the nozzle 20. The center axis L1 of the transducer 15 may pass through a portion of the second recessed portion 112 at which the third recessed portion 113 is formed. Specifically, the first line L2 may be orthogonal to the center axis L1 of the transducer 15, and the second line L4 may be orthogonal to the center axis L3 of the nozzle 20. An angle θt between the first line L2 and the second line L4 may be an acute angle. The angle θt may be 19 degrees or less.

In another example, the center axis L1 of the transducer 15 may be aligned with or parallel to the center axis L3 of the nozzle 20. The center axis L1 of the transducer 15 may pass through the nozzle 20. The angle θt may be zero degrees.

The second recessed portion 112 of the bottom cover 11 may define the front room FR between the transducer 15 and the nozzle 20. A diameter (width) of the front room FR may decrease toward the nozzle 20. A maximum diameter (width) of the front room FR may correspond to a diameter (width) of the diaphragm 15e having the edge 15f. A minimum diameter (width) of the front room FR may correspond to a diameter (width) of the inlet 20i of the nozzle 20. The second recessed portion 112 may be generally bowl-shaped. An inner surface of the second recessed portion 112 may be a curved surface. Accordingly, the second recessed portion 112 may smoothly guide the sound of the transducer 15 to the nozzle 20. The second recessed portion 112 may have a shape that minimizes reflection or diffraction of the sound of the transducer 15 by the second recessed portion 112.

The hollow space 20H of the nozzle 20 may have a constant diameter. The second recessed portion 112 defining the front room FR and the nozzle 20 having the hollow space 20H may be generally funnel-shaped. The second recessed portion 112 may form an obtuse angle θr with respect to the nozzle 20.

The mic 18 may be adjacent to the opening 110h and mounted to the bottom cover 11. The mic 18 may be inserted into the third recessed portion 113, thereby minimizing the height of the mic 18 and the seventh part 17g that protrude from the second recessed portion 112. A portion of the second recessed portion 112, at which the third recessed portion 113 is formed, may be referred to as an inclined portion or an inclined surface. The inclined surface may be wider than other parts of the second recessed portion 112. For example, a center axis L6 of the mic 18 that passes through the center of the mic 18 may pass through the center of the diaphragm 15e or may be slightly offset from the center. That is, the mic 18 may face the center of the diaphragm 15e. The mic 18 may be spaced apart from the transducer 15 by a certain distance Dt or more. For example, the distance Dt may be ⅕ or ¼ of the diameter of the diaphragm 15e. For example, the distance Dt between the transducer 15 and the mic 18 may be 1.4 mm or more. The distance Dt may be a distance between the first line L2 and the third line L5 that is parallel to the first line L2 and passes through the mic 18. Accordingly, it is possible to minimize the effect of the mic 18 on the sound generated by the transducer 15.

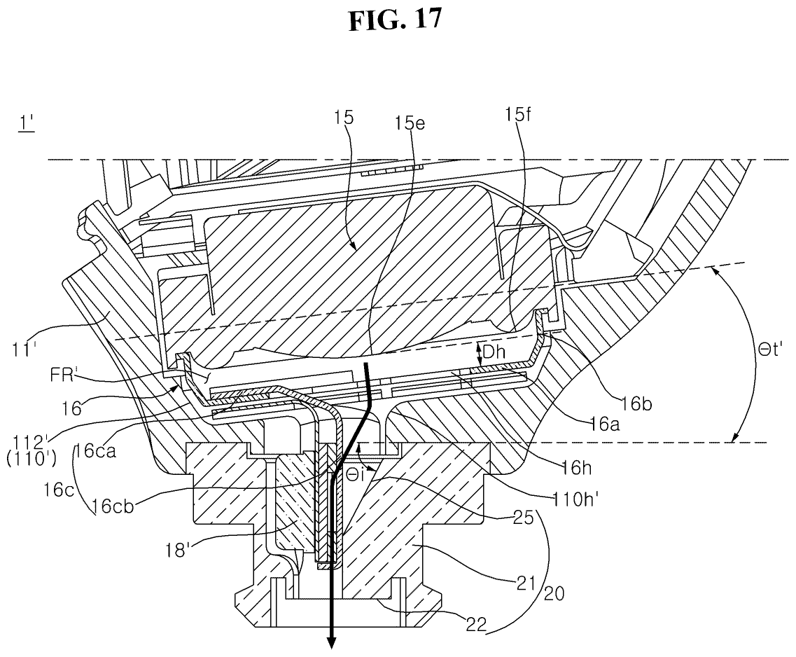

Referring to FIGS. 17 to 19, a second recessed portion 112′ of a bottom cover 11′ of a sound device l′ may define a front room FR′ between the transducer 15 and the nozzle 20. The second recessed portion 112′ may have a generally round tray shape. That is, the second recessed portion 112′ and the nozzle 20 may have a T-shaped cross section, and the second recessed portion 112 and the nozzle 20 described above with reference to FIG. 16 may have a Y-shaped cross section. A holder 16 may be disposed in the front room FR′ and coupled to the transducer 15. The holder 16 may have a round tray shape corresponding to the second recessed portion 122′, and a hole 16h may be formed in a central portion of the holder 16. Accordingly, sound waves generated by the transducer 15 may be provided to the nozzle 20 through the hole 16h of the holder 16 and an opening 110h′ of the bottom cover 11′.

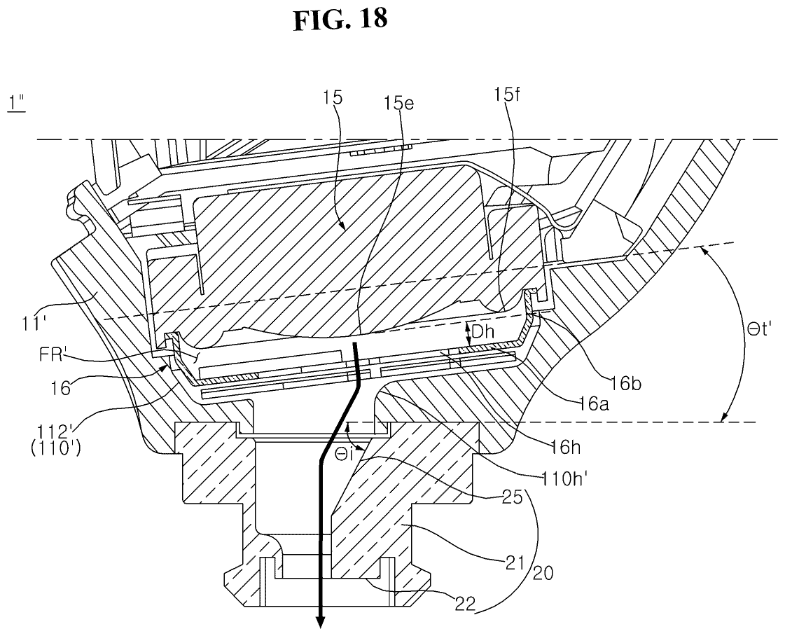

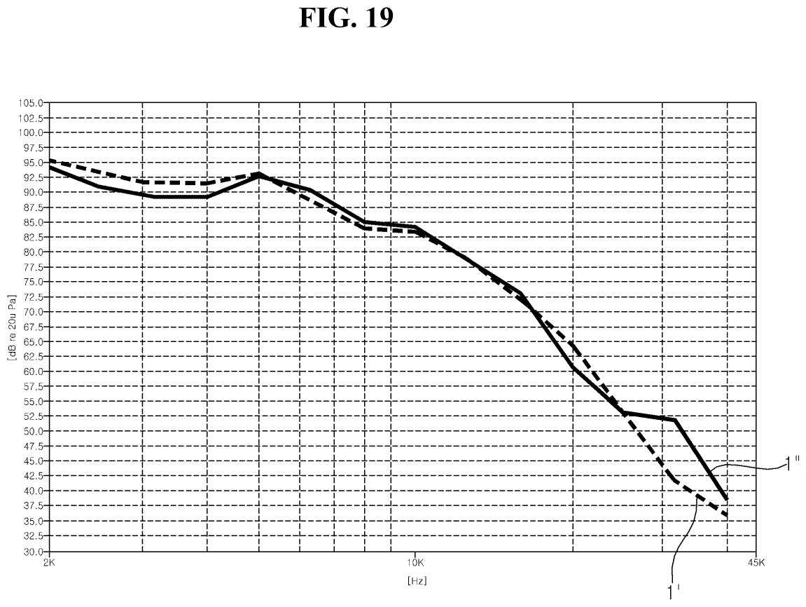

Referring to FIG. 17, a mic 18′ may be coupled to the holder 16 by a coupling portion 16c and disposed inside the nozzle 20. Referring to FIG. 18, the mic 18′ may be removed from a sound device 1″. Referring to FIG. 19, it can be seen that in a high frequency band of about 25 kHz to 40 kHz, sound pressure of the sound device 1″ (see the solid line), from which the mic 18′ is removed, is higher by a maximum of 10 dB than sound pressure of the sound device 1′ (see the dotted line) including the mic 18′. That is, removing the mic 18′ from the inside of the nozzle 20 may be beneficial in increasing the sound pressure of the sound device.

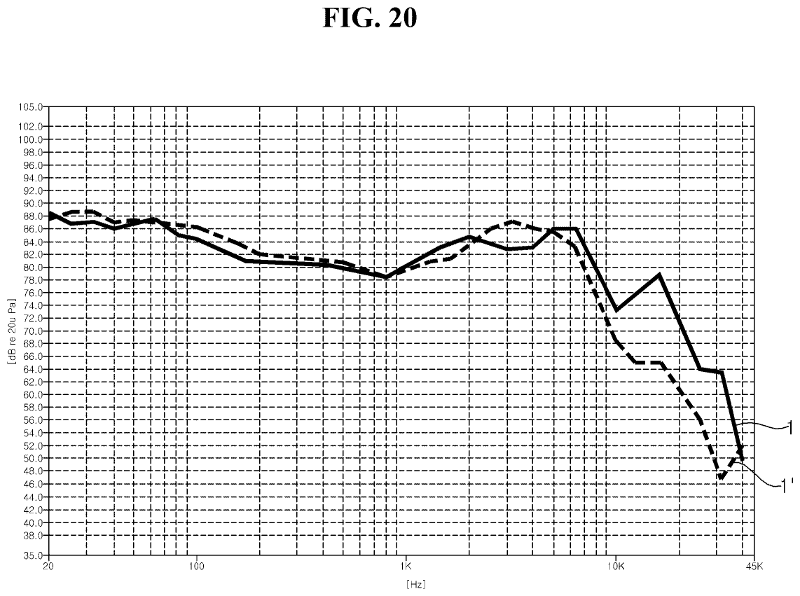

Referring to FIG. 20 together with FIGS. 16 and 17, it can be seen that in a high frequency band of about 20 kHz to 40 kHz, sound pressure of the sound device 1 (see the solid line) including the mic 18 is higher by a maximum of 16 dB than sound pressure of the sound device 1′ (see the dotted line) including the mic 18′. This is because the mic 18 of the sound device 1 is located outside the nozzle 20, and the bowl-shaped second recessed portion 112 of the sound device 1 smoothly guides the sound of the transducer 15 to the nozzle 20.

Accordingly, the sound quality (particularly, sound quality in a high frequency band) of the sound device 1 may be improved. In addition, the sound device 1 may provide active noise cancelling.

Referring to FIGS. 1 to 20, a sound device 1 may include: a housing 10; a nozzle 20 protruding from the housing 10, the nozzle 20 including an inlet 20i which faces an inner space of the housing 10 and an outlet 20e which is opposite to the inlet 20i; a transducer 15 including a diaphragm 15e and disposed in the inner space of the housing 10; and a microphone 18 adjacent to the inlet 20i of the nozzle 20 and coupled to an inner surface of the housing 10.

The housing 10 may include a front room FR between the transducer 15 and the nozzle 20, wherein the microphone 18 may face the front room FR.

A width of a portion of the housing 10 forming the front room FR may decrease toward the nozzle 20.

An inner surface of the portion of the housing 10 forming the front room FR may be a curved surface.

The nozzle 20 and the portion of the housing 10 forming the front room FR may be generally funnel-shaped.

The housing 10 may further include a recessed portion 113 recessed from the inner surface of a portion of the housing 10 which forms the front room FR, wherein the microphone 18 may be inserted into the recessed portion 113.

The microphone 18 may be spaced apart from the transducer 15 by a certain distance Dt or more.

The transducer 15 may be inclined by a certain angle or less with respect to a center axis L3 of the nozzle 20.

The housing 1 may include: a first recessed portion 111 recessed from the inner surface of the housing 10; and a second recessed portion 112 which is recessed from the first recessed portion and at which the nozzle 20 is formed, the second recessed portion 112 to which the microphone 18 is coupled, wherein the transducer 15 may include a frame 15a disposed on the first recessed portion 111 and to which the diaphragm 15e is coupled.

The transducer 15 may further include a rib 15g protruding from the frame 15a toward the second recessed portion 112, and covering a portion of the diaphragm 15e.

The housing 10 may further include a third recessed portion 113 which is recessed from the second recessed portion 112 and in which the microphone 18 is disposed, wherein the microphone 18 may be spaced apart from the diaphragm 15e while facing the diaphragm 15e.

The housing 10 may further include a vent hole 11v formed in the housing 10, wherein air passing through the vent hole 11v may be provided to the microphone 18 through the transducer 15.

The transducer 15 may play sound having an anti-phase with respect to noise recognized by the microphone.

The sound device 1 may further include an inner bracket 13 that divides the inner space of the housing 10 into a first space 10S and a second space 10S2, wherein the transducer 15 and the microphone 18 may be located in the first space 10S1, wherein the first space 10S1 may include: a back room BR formed between the inner bracket 13 and the transducer 15; and a front room FR formed between the transducer 15 and the nozzle 20, wherein the vent hole 11v may face the back room BR.

The sound device 1 may further include a noise recognition microphone 12n located in the second space 10S2, wherein the housing 10 may include a noise inflow hole 12nh formed in the housing 10 and communicating with the noise recognition microphone 12n, and the transducer 15 may play sound that has an anti-phase with respect to noise acquired from the noise recognition microphone 12n, wherein the microphone 18 in the first space 10S1 may be a feedback microphone.

The sound device according to the present disclosure has the following effects.

According to at least one of the embodiments of the present disclosure, a sound device with improved acoustic performance may be provided.

According to at least one of the embodiments of the present disclosure, a sound device with improved sound quality in a high (or ultra-high) frequency band may be provided.

According to at least one of the embodiments of the present disclosure, a sound device equipped with the Active Noise Cancellation (ANC) function may be provided.

Certain embodiments or other embodiments of the invention described above are not mutually exclusive or distinct from each other. Any or all elements of the embodiments of the invention described above may be combined or combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except in the case where it is described that the combination is impossible.

The foregoing embodiments are merely examples and are not to be considered as limiting the present disclosure. The scope of the present disclosure should be determined by rational interpretation of the appended claims, and all modifications within the equivalents of the disclosure are intended to be included within the scope of the present disclosure.

What is claimed is:

1. A sound device comprising:
a housing including a recessed portion and an inner space;
a nozzle protruding from the housing, the nozzle including:
an inlet connected to the inner space of the housing; and
an outlet located at an opposite side of the nozzle than the inlet;
a transducer including a diaphragm disposed in the inner space of the housing; and
a microphone located in the recessed portion of the housing and adjacent to the inlet of the nozzle, the microphone being coupled to an inner surface of the housing.

2. The sound device of claim 1, wherein the housing further includes a front room located between the transducer and the nozzle, and
wherein the microphone is located at an edge portion of the front room.

3. The sound device of claim 2, wherein a maximum width of a portion of the housing including the front room decreases toward the nozzle.

4. The sound device of claim 3, wherein an inner surface of the portion of the housing including the front room is a curved surface.

5. The sound device of claim 4, wherein a maximum width of the front room decreases towards the nozzle to form a funnel shape with the nozzle.

6. The sound device of claim 2, wherein the recessed portion is recessed from an inner surface of a portion of the housing including the front room.

7. The sound device of claim 6, wherein the microphone is spaced apart from the transducer.

8. The sound device of claim 1, wherein the transducer is inclined at an angle with respect to a center axis of the nozzle.

9. The sound device of claim 1, wherein the recessed portion comprises:
a first recessed portion recessed from the inner surface of the housing; and
a second recessed portion recessed from the first recessed portion and at which the nozzle is located, and
wherein the transducer further includes a frame disposed on the first recessed portion, the diaphragm being coupled to the frame.

10. The sound device of claim 9, wherein the transducer further includes a rib protruding from the frame toward the second recessed portion, the rib surrounding the diaphragm.

11. The sound device of claim 9, wherein the housing further comprises a third recessed portion which is recessed from the second recessed portion and in which the microphone is located, and
wherein the microphone is spaced apart from the diaphragm.

12. The sound device of claim 1, wherein the housing further includes a vent hole located in the housing, the vent hole being configured so that air that passes through the vent hole is provided to the microphone through the transducer.

13. The sound device of claim 12, wherein the transducer is configured to play a sound having an anti-phase with respect to noise recognized by the microphone.

14. The sound device of claim 12, further comprising an inner bracket that divides the inner space of the housing into a first space and a second space,
wherein the transducer and the microphone are located in the first space, wherein the first space comprises:
a back room located between the inner bracket and the transducer; and
a front room located between the transducer and the nozzle, and
wherein the vent hole is connected to the back room.

15. The sound device of claim 14, further comprising a noise recognition microphone located in the second space,
wherein the housing further includes a noise inflow hole located in the housing, the noise inflow hole being configured to allow noise from an exterior of the housing to be received by the noise recognition microphone,
wherein the transducer is configured to play a sound having an anti-phase with respect to the noise acquired from the noise recognition microphone, and
wherein the microphone located in the first space is a feedback microphone.

16. A sound device comprising:
a housing;
a nozzle protruding from the housing, the nozzle including:
an inlet connected to an inner space of the housing; and
an outlet located at an opposite side of the nozzle than the inlet;
a transducer including a diaphragm disposed in the inner space of the housing, the transducer being located at a first angle with respect to a center axis of the nozzle; and
a microphone coupled to an inner surface of the housing adjacent to the inlet of the nozzle, the microphone being located at a second angle different from the first angle with respect to the center axis of the nozzle.

17. The sound device of claim 16, wherein a distance between the microphone and the nozzle is smaller than a distance between the transducer and the nozzle.

18. The sound device of claim 16, wherein the inlet of the nozzle includes a curved surface that narrows an opening of the inlet as the curved surface gets closer to the outlet, and wherein the outlet of the nozzle includes a groove located at an edge portion of the outlet.

19. The sound device of claim 16, wherein the microphone is coupled to the housing by a guide pin, the guide pin being located at a central portion of the microphone.

20. The sound device of claim 19, wherein a distance between the guide pin and the transducer is smaller than a distance between the microphone and the transducer.
